(19) United States
(12) Patent Application Publication
(10) Pub. No.: US 2026/0048667 A1
(43) Pub. Date: Feb. 19, 2026

(54) PROPULSION ASSEMBLY OF A RIDE SYSTEM

(71) Applicant: Universal City Studios LLC, Universal City, CA (US)

(72) Inventors: Lucas Gorentz, Orlando, FL (US); Michael Beatrice, Orlando, FL (US)

(21) Appl. No.: 19/303,061

(22) Filed: Aug. 18, 2025

Related U.S. Application Data
(60) Provisional application No. 63/684,703, filed on Aug. 19, 2024.

(51) Int. Cl. B60L 15/00; A63G 7/00; B60L 13/04

(52) U.S. Cl. CPC B60L 15/005; A63G 7/00; B60L 13/04; B60L 2200/26

(57) ABSTRACT

A propulsion assembly for a ride system includes a beam, a motor configured to generate a magnetic field that propels a ride vehicle of the ride system in response to the beam entering the magnetic field, and an absorber configured to enable and dampen a movement of the beam or the motor in response to an engagement between the beam and the motor.

### CROSS-REFERENCE TO RELATED APPLICATION

This application claims priority from and the benefit of U.S. Provisional Application No. 63/684,703, entitled “PROPULSION ASSEMBLY OF A RIDE SYSTEM”, filed Aug. 19, 2024, which is hereby incorporated by reference in its entirety

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

The present disclosure relates generally to the field of amusement parks. More specifically, embodiments of the present disclosure relate to systems and methods associated with a propulsion assembly of a ride system.

Various amusement rides and exhibits have been created to provide guests with unique interactive, immersive, motion, and/or visual experiences. For example, an amusement park may include an attraction system, such as a ride (e.g., a roller coaster, a train, etc.), an extended reality system, an interactive experience, a theatrical show, and the like. The attraction system may include a ride vehicle that regularly transports guests of the amusement park. Various applications may utilize mechanisms to actively accelerate (e.g., speed up, propel) and/or decelerate (e.g., slow, stop) the ride vehicle carrying the guests. In particular, propulsion assemblies may be employed to accelerate the ride vehicle along a ride vehicle path (e.g., a track). Such propulsion assemblies may operate to accelerate the ride vehicle based on a proximity between a component of the propulsion assembly integrated with the ride vehicle path and an additional component of the propulsion assembly integrated with the ride vehicle.

Unfortunately, traditional propulsion assemblies may be inefficient or ineffective in accelerating the ride vehicle due to insufficient or undesirable proximity characteristics between the above-described components of the propulsion assembly, particularly in areas of the ride vehicle path having relatively high curvature (e.g., crests, valleys, ascents, descents, loops, curved transitions between straight portions of the ride vehicle path, etc.). For example, undesirable proximity between the component of the propulsion assembly integrated with the ride vehicle path and the additional component of the propulsion assembly integrated with the ride vehicle may occur if the component integrated with the ride vehicle path extends too far above the ride vehicle path, which may lead to interference between the component and the additional component, causing wear, tear, fatigue, or failure. Additionally or alternatively, insufficient proximity may occur if the component of the propulsion assembly integrated with the ride vehicle path is retracted too far away from the oncoming ride vehicle and the additional component of the propulsion assembly integrated with the oncoming ride vehicle. Accordingly, it is now recognized that improved systems and methods for propulsion assemblies configured to accelerate ride vehicles are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a propulsion assembly for a ride system includes a beam, a motor configured to generate a magnetic field that propels a ride vehicle of the ride system in response to the beam entering the magnetic field, and an absorber configured to enable and dampen a movement of the beam or the motor in response to an engagement between the beam and the motor.

In an embodiment, a ride system includes a ride vehicle path, a ride vehicle, and a magnetic beam integrated with one of the ride vehicle path or the ride vehicle. The ride system also includes a motor integrated with the other of the ride vehicle path or the ride vehicle and a controller configured to selectively control a current directed to the motor to generate a magnetic field that propels the ride vehicle in response to the magnetic beam entering the magnetic field. The ride system further includes an absorber configured to enable and dampen a movement of the magnetic beam or the motor in response to an engagement between the magnetic beam and the motor.

In an embodiment, a method of propelling a ride vehicle of a ride system, includes generating, via a motor, a magnetic field that propels a ride vehicle in response to a magnetic beam entering the magnetic field and dampening a movement of the magnetic beam or the motor via an absorber and in response to an engagement between the magnetic beam and the motor.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of a ride system that includes a propulsion assembly with at least one movable component, in accordance with embodiments described herein;

FIG. 2 is a block diagram of a propulsion assembly of a ride system with at least one movable component, and a control system for controlling the propulsion assembly, in accordance with embodiments described herein;

FIG. 3 is a perspective view of a portion of a ride system that includes a propulsion assembly having a beam coupled to a ride vehicle, a motor coupled to a ride vehicle path, and one or more absorbers, in accordance with embodiments described herein;

FIG. 4 is a cross-sectional perspective view of a portion of a ride system that includes a propulsion assembly having a beam coupled to a ride vehicle, a motor coupled to a ride vehicle path, and one or more absorbers, in accordance with embodiments described herein;

FIG. 5 is a cross-sectional perspective view of a portion of a ride system that includes a propulsion assembly having a beam coupled to a ride vehicle, a motor coupled to a ride vehicle path, and one or more absorbers, in accordance with embodiments described herein;

FIG. 6 is a perspective view of a portion of a ride system that includes a propulsion assembly including one or more springs and one or more rollers, in accordance with embodiments described herein;

FIG. 7 is a side view of a portion of a ride system that includes a propulsion assembly having a beam coupled to a ride vehicle path, a motor coupled to a ride vehicle, and one or more absorbers, in accordance with embodiments described herein; and

FIG. 8 is a process flow diagram of a method employed to operate a ride system that includes a propulsion assembly, in accordance with embodiments described herein.

### DETAILED DESCRIPTION

One or more specific embodiments will be described below. In an effort to provide a concise description of these embodiments, not all features of an actual implementation are described in the specification. It should be appreciated that, in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure is directed toward propulsion assemblies of a ride system. More particularly, the present disclosure is directed toward a propulsion assembly that improves proximity and/or engagement characteristics between a motor (or a propulsion component coupled to or forming a part of the motor, such as a fin), such as a linear induction motor (LIM) or linear synchronous motor (LSM), and a beam (e.g., magnetic beam, aluminum beam, copper beam, etc.), among other technical benefits. As described in detail below, the improved proximity and/or engagement characteristics between the motor and the beam, enabled by the presently disclosed propulsion assembly, improves an effectiveness and/or efficiency of propelling (e.g., accelerating, speeding up) a ride vehicle along a ride vehicle path (e.g., track).

Amusement parks and entertainment venues may include ride systems (e.g., roller coasters, trains, etc.) to entertain guests. A ride system may include, for example, a ride vehicle transported along a ride vehicle path (e.g., a track). Further, the ride system may include one or more assemblies configured to brake (e.g., decelerate, slow down) and/or accelerate (e.g., speed up, propel) the ride vehicle at a designated segment of the ride vehicle path. For example, a propulsion assembly may be configured to accelerate the ride vehicle along the ride vehicle path via a magnetic force (e.g., electromagnetic force) established between a component of the propulsion assembly integrated with the ride vehicle path (e.g., the motor) and an additional component of the propulsion assembly integrated with the ride vehicle (e.g., the beam).

It is presently recognized that movable aspects (e.g., actively or inactively movable aspects) of the propulsion assembly may enable improved engagement or proximity characteristics between the component of the propulsion assembly integrated with the ride vehicle path and the additional component of the propulsion assembly integrated with the ride vehicle, particularly in areas of the ride vehicle path having relatively high curvature (e.g., crests, valleys, ascents, descents, loops, curved transitions between straight portions of the ride vehicle path, etc.). Indeed, by enabling movement of the component of the propulsion integrated with the ride vehicle path, the additional component of the propulsion assembly integrated with the ride vehicle, or both, proximity and/or engagement between the component and the additional component can be ensured without potentially undesirable interference occurring between the component and the additional component. That is, insufficient proximity or engagement (i.e., where the component and the additional component are undesirably far from each other, which may reduce an effectiveness of propulsion) and undesirable proximity or engagement (i.e., where the component and the additional component undesirably interfere with each other, which may cause wear, tear, fatigue, or failure) are avoided by way of present disclosed embodiments.

For example, the propulsion assembly may include one or more absorbers (e.g., springs, air bladders, hydraulic cylinders, pneumatic bladders, etc.) coupled to (e.g., directly or indirectly), a first component of the propulsion assembly, such as a motor (e.g., linear induction motor or LIM, linear synchronous motor or LSM, etc.) disposed in the ride vehicle path, disposed on the ride vehicle path, or otherwise integrated with the ride vehicle path. The propulsion assembly may also include a second component, such as a beam (e.g., magnetic beam), positioned on the ride vehicle. As the ride vehicle moves across the ride vehicle path and approaches the motor, contact or engagement between the motor (or componentry coupled to or forming a part of the motor, such as a fin) and the beam may force the motor downward.

The absorbers are configured to enable and dampen the downward movement of the motor in response to the engagement. In accordance with embodiments of the present disclosure, the absorbers may be incorporated between the motor and a mounting plate disposed on the track. Further, the absorbers may provide a constant force (e.g., upwards force) on the motor to facilitate increased engagement with the beam, but without said engagement causing undesirable and/or extensive interference between the motor and the beam. In other embodiments, the absorbers are disposed between the beam and the ride vehicle, enabling and dampening upwards movement of the beam as the beam and the motor engage. In still other embodiments, the motor is coupled to the ride vehicle and the beam is coupled to the ride vehicle path. In general, presently disclosed embodiments include at least one movable (e.g., actively or inactively movable) component of the propulsion assembly configured to move in response, for example, to engagement with another component of the propulsion assembly. Desirable proximity or engagement between the components is established, thereby improving an accelerative force imparted to the ride vehicle via the propulsion assembly, without undesirable or extensive interference between the components being established, thereby reducing a possibility of wear, tear, fatigue, extensive frictional deceleration, or failure.

In some embodiments, the motor includes an LIM and/or an LSM, as previously referenced. In general, LIMs and LSMs in propulsion assemblies may use electromagnets to propel ride vehicles based on track location, a speed of the ride vehicle, and/or other environmental factors. For example, LSMs may be configured to propel (e.g., accelerate) the ride vehicle via an electrical current induced within the motor via a power source. In some instances, the directional electrical current may be activated, deactivated, or varied in strength externally via a power source. Further, in some embodiments, LIMs may include one or more motors. A linearly moving magnetic field may be produced by the motors. As the ride vehicle passes over the motors, eddy currents (e.g., according to Len's Law) may be induced opposing the linearly moving magnetic field. The opposing linearly moving magnetic field and the eddy currents may promote movement (e.g., propulsion, braking) of the ride vehicle. For example, the motor (e.g., a fin of the motor) may come into a sufficient proximity with the ride vehicle (e.g., the beam of the ride vehicle) causing magnetic currents generated in the motor to interact with the beam disposed on the ride vehicle as the beam passes over the motor, thereby generating (e.g., inducing) eddy currents that cause a force (e.g., magnetic force) propelling a travel direction of the ride vehicle. This force accelerates the ride vehicle as it moves along a travel direction. It should be noted that deceleration forces may also be included in the propulsion assembly.

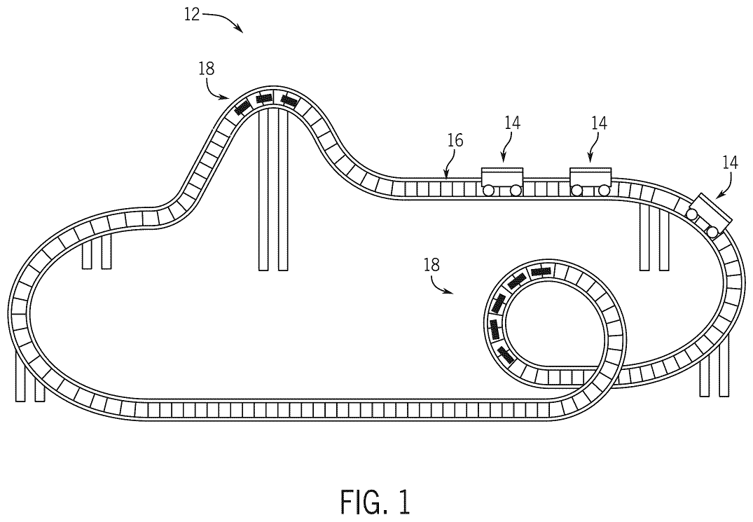

Turning now to the drawings, FIG. 1 is a schematic illustration of an embodiment of a ride system 12 (e.g., for an entertainment venue or amusement park). In the illustrated embodiment, the ride system 12 includes a ride vehicle 14, a ride vehicle path 16 (e.g., a track, a water-based path such as a river, a floor, a wired path, etc.), and a propulsion assembly 18. As illustrated in (and described in greater detail with respect to) later drawings, certain aspects of the propulsion assembly 18 (e.g., a motor or a beam) may be integrated with the ride vehicle path 16, and certain other aspects of the propulsion assembly 18 (e.g., the other of the beam or the motor) may be integrated with the ride vehicle 14.

The ride system 12 may be configured to guide the ride vehicle 14 along the ride vehicle path 16, and the propulsion assembly 18 may be configured to accelerate (e.g., speed up) the ride vehicle 14 along the ride vehicle path 16. In some embodiments, multiple instances of the ride vehicle 14 may be employed. For example, the ride vehicles 14 may be coupled together to form an assembly of the ride vehicles 14, or the ride vehicles 14 may be detached from each other and/or independently movable. It should be understood that while certain embodiments of the ride system 12 are discussed in the context of a roller coaster in the present disclosure, other types of the ride system 12 may also be employed, including trains, transportation vehicles, a gondola lift, water-based rides, and the like.

As the ride vehicle 14 moves along the ride vehicle path 16, the ride vehicle 14 may pass over a portion of the propulsion assembly 18 integrated with the ride vehicle path 16, such as a motor of the propulsion assembly 18. In certain embodiments, the ride vehicle 14 may pass over multiple instances of the propulsion assembly 18 (or portions thereof). The propulsion assembly 18 (or portion thereof) may be formed in, or otherwise interfaced with, a portion of the ride vehicle path 16 (e.g., the track) or a structure supporting or otherwise coupled to the ride vehicle path 16 (e.g., one or more structural beams, one or more platforms, etc.).

In general, the propulsion assembly 18 includes a beam (e.g., disposed on the ride vehicle 14), one or more motors (e.g., disposed on the ride vehicle path 16), one or more absorbers, and the like. In some embodiments, the motor(s) of the propulsion assembly 18 induce a magnetic field that propels the ride vehicle 14 in response to the beam entering the magnetic field. As the beam enters the magnetic field and engages the motor of the propulsion assembly 18, absorbers of the propulsion assembly 18 supporting, for example, the motor may be configured to enable and dampen motion of the motor, while maintaining magnetic propulsion of the ride vehicle 14. That is, the absorbers may allow the motor, for example, to move away from the beam to combat undesirable interference therebetween, but may also push the motor upwardly toward the beam to enable desirable proximity or engagement therebetween. Magnetic propulsion of the ride vehicle 14 may be controlled via a sufficiently close proximity between the beam and the motor, while avoiding damage to the motor, the beam, or other aspects of the ride system 12.

Further, in some embodiments, the propulsion assembly 18 may be used in combination with a drive tire or roller assembly, which may further reduce frictional forces and/or undesirable interference between aspects of the propulsion assembly 18 (e.g., the beam on the ride vehicle 14, the motor on the ride vehicle path 16, etc.). Presently disclosed features of the propulsion assembly 18 may be particularly beneficial in areas of the ride vehicle path 16 having relatively high curvature, such as peaks, valleys, crests, ascents, loops, etc. For example, the movable nature of certain aspects of the propulsion assembly 18, described in greater detail with reference to later drawings, enables more precise alignment between aspects of the propulsion assembly 18 on the ride vehicle path 16 and other aspects of the propulsion assembly 18 on the ride vehicle 14.

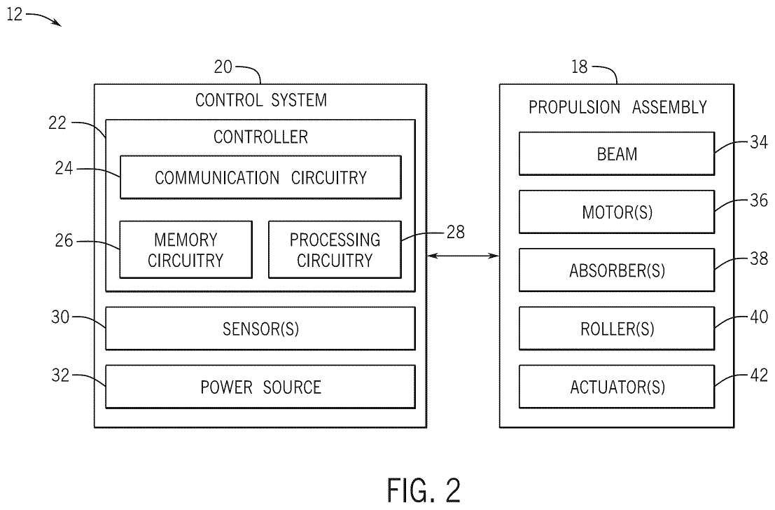

With the foregoing in mind, FIG. 2 is a block diagram of an embodiment of the propulsion assembly 18 of the ride system 12, wherein the propulsion assembly 18 includes at least one movable component, and a control system 20 of the ride system 12, wherein the control system 20 is configured to control certain aspects of the propulsion assembly 18. As shown, the control system 20 may include one or more controllers 22 (referred to for purposes of brevity below as “the controller 22”), communication circuitry 24 of the controller 22, memory circuitry 26 of the controller 22, processing circuitry 28 of the controller 22, one or more sensors 30 (referred to for purposes of brevity below as “the sensor 30”), and a power source 32. The propulsion assembly 18 may include a beam 34 (e.g., magnetic, permanent magnet, aluminum, copper, and the like), one or more motors 36 (e.g., LIM, LSM), one or more absorbers 38 (e.g., springs, bladders), one or more rollers 40, one or more actuators 42, or a combination thereof.

The communication circuitry 24 may enable wired or wireless communication with the propulsion assembly 18 and other componentry, such as the sensor(s) 30. As such, the communication circuitry 24 may include a wireless card, a real-time communication network, such as the Internet, and/or a cloud-based computing system that may be capable of communicating with other devices in accordance with the present disclosure.

The controller 22 may be configured to receive sensor data from the sensor(s) 30 (e.g., position sensor, proximity sensor, speed sensor, laser or infrared sensor, load cell sensor, camera, etc.). The memory circuitry 26 of the controller 22 may include a volatile memory, such as random-access memory (RAM), and/or nonvolatile memory, such as read-only memory (ROM). The memory circuitry 26 may store a variety of information and may be used for various purposes. For example, the memory circuitry 26 may store processor-executable instructions (e.g., hardware, software) for the processing circuitry 28 to execute, such as instructions for controlling various components of the ride system 12. For example, the instructions may control the propulsion assembly 18. The processing circuitry 28, which may be one or more processors, may include any suitable processor or microprocessor capable of executing processor executable code. Moreover, the processing circuitry 28 may include multiple microprocessors, one or more “general-purpose” microprocessors, one or more special-purpose microprocessors, and/or one or more application specific integrated circuits (ASICs), or some combination thereof. For example, the processing circuitry 28 may include one (or more than one) reduced instruction set (RISC) or complex instruction set (CISC) processors. The memory circuitry 26 and/or the processing circuitry 28, or any additional memory and/or processor, may be located in any suitable portion of the ride system 12 in FIG. 1.

The sensor(s) 30 may include a proximity sensor configured to acquire positional information of the ride vehicle 14 in FIG. 1 in relation to the ride vehicle path 16 in FIG. 1. In some embodiments, the sensor 30 may include a speed sensor that tracks information related to a speed of the ride vehicle 14. Additionally or alternatively, the sensor(s) 30 may be configured to detect load characteristics corresponding to the ride vehicle 14, environmental conditions surrounding the ride system 12 of FIG. 1, and/or other information. In some embodiments, the controller 22 determines whether sensor feedback indicates that the ride vehicle 14 is traveling at a speed greater than a threshold speed, and controls the propulsion assembly 18 in response to sensor feedback. It should be noted that the controller 22 may be capable of controlling the propulsion assembly 18 to change a speed of the ride vehicle 14 to a particular speed, or to a particular range of speeds. That is, the controller 22 may control a timing of activating and/or deactivating the propulsion assembly 18 to change the speed of the ride vehicle 14 by a pre-determined amount, if desired. As previously described, the pre-determined amount may be calculated by the controller 22 based on the sensor feedback received by the controller 22 from the sensor(s) 30.

The power source 32 may include any suitable power source, including (but not limited to) a battery, a solar panel, an electrical generator, or any combination thereof. In some embodiments, the power source 32 may supply power to the controller 22, the propulsion assembly 18 (or individual components thereof), the sensor(s) 30, and/or some other aspect of the ride system 12 in FIG. 1.

The beam 34 of the propulsion assembly 18 may include any suitable material, including (but not limited to) a magnetic material, a permanent magnet (e.g., rare-earth magnets), aluminum, copper, steel, and the like. In some embodiments, the beam 34 may be mounted on the ride vehicle (e.g., disposed on or adjacent to a chassis of the ride vehicle). Alternatively, the beam 34 may be mounted on the ride vehicle path 16 (FIG. 1) (e.g., the track). The motor 36 of the propulsion assembly 18 may include an LIM motor, an LSM motor, one or more fins, one or more stators, or a combination thereof. In some embodiments, the motor 36 may be configured to generate a magnetic field that propels (e.g., accelerates) the ride vehicle 14 (FIG. 1) of the ride system 12 in response to the beam 34 entering the magnetic field. For example, the controller 22 may control the power source 32 to induce an electrical current within the motor 36. In this manner, the electrical current may be selectively generated in response to determining that propulsion of the ride vehicle 14 is needed. That is, the electrical current may be generated at particular times in which the propulsion assembly 18 is activated. Additionally and/or alternatively, a direction of the electrical current may be controlled via the controller 22 to change a direction of the magnetic field. The motor 36 of the propulsion assembly 18 may accelerate or decelerate the ride vehicle 14 based on the direction of the electrical current.

The absorbers 38 of the propulsion assembly 18 may be configured to enable and dampen movement of the beam 34 or the motor 36 of the propulsion assembly 18 in response to an engagement between the beam 34 and the motor 36 (e.g., magnetic engagement, physical engagement). In some embodiments, the absorbers include springs, bladders (e.g., air bladders, pneumatic bladders), hydraulic cylinders, and/or the like. In some embodiments, the absorbers 38 are coupled to a mounting plate of the ride vehicle path. As the ride vehicle 14 (FIG. 1) passes over the absorbers 38, engagement between the beam 34 and the motor 36 may be dampened as a portion of the propulsion assembly 18 (e.g., the beam 34 or the motor 36) is displaced along a direction of travel of the ride vehicle. For example, the ride vehicle path may include areas of relatively high curvature (e.g., ascents, descents, peaks, valleys, crests, loops, turns, and the like) in which engagement of the beam 34 and the motor 36 may occur at various heights. Movement (e.g., displacement) of the portion (e.g., the beam 34 or the motors 36) of the propulsion assembly 18 may prevent undesirable interface between the beam 34 and the motor 36 while still maintaining sufficient proximity between the beam 34 and the motor 36, allowing magnetic propulsion to accelerate (e.g., speed up) the ride vehicle.

The rollers 40 of the propulsion assembly 18 may include any suitable component used to reduce friction and ensure sufficient proximity without undesirable interference between the beam 34 and the motor 36, including (but not limited to) one or more casters, one or more roller bearings, one or more wheels, and the like. It should be noted that the rollers 40 may be excluded from one or more embodiments of the present disclosure. However, in some embodiments, it may be advantageous to include the rollers 40 on one or more portions of the propulsion assembly 18 to reduce friction during engagement between the beam 34 and the motor 36. The rollers 40 may be positioned between the beam 34 and the motor 36, such as being disposed on the beam 34, the motor 36, or a combination thereof. Further, in some embodiments, the propulsion assembly 18 may include an actuator 42. The actuator 42 may include an actuating cylinder, an electric actuator, a rotary actuator, a pneumatic actuator. and the like. In some embodiments, the actuator 42 may be used to control a relative position between the beam 34 and the motor 36. In some instances, the controller 22 may selectively control the actuator 42 to change the relative position. However, in other embodiments, movement of the beam 34 and/or the motor 36 is caused by engagement therebetween, where the absorbers 38 enable and dampen the movement to ensure sufficient and desirable proximity between the beam 34 and the motor 36, as previously described.

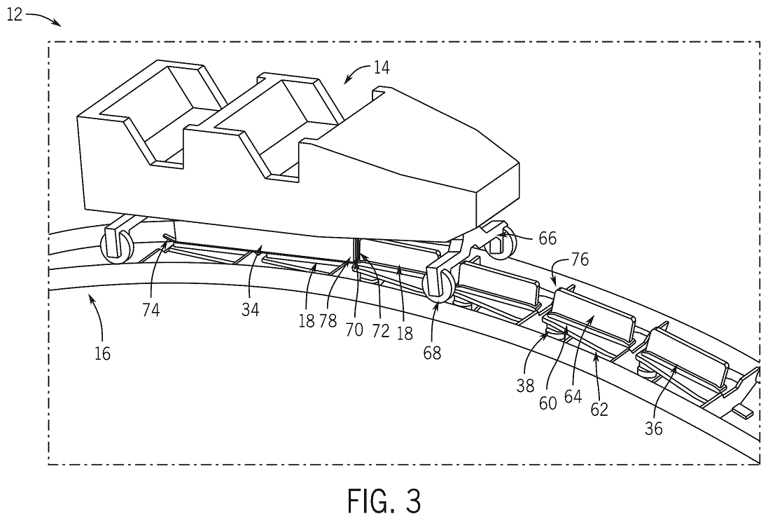

With the foregoing in mind, FIG. 3 provides a more detailed perspective view of a portion of an embodiment of the ride system 12 of FIG. 1, including various instances of the propulsion assembly 18. In the illustrated embodiment, the ride system 12 includes the ride vehicle path 16 (e.g., the track), the ride vehicle 14, and the propulsion assembly 18. As shown, a portion of the propulsion assembly 18 may be disposed on (or otherwise interfaced with) the ride vehicle path 16, and an additional portion of the propulsion assembly 18 may be disposed on (or otherwise interfaced with) the ride vehicle 14. For example, the propulsion assembly 18 includes the beam 34 mounted on the ride vehicle 14, the motor 36 coupled to the ride vehicle path 16 via a mounting block 60, and the one or more absorbers 38 coupled to a mounting plate 62 of the ride vehicle path 16. In some embodiments, the motor 36 is disposed in or forms a part of the mounting block 60, and a fin 64 corresponding to the motor 36 extends therefrom.

In the illustrated embodiment, the ride vehicle 14 includes a chassis 66 and one or more wheels 68 configured to direct the ride vehicle 14 along the ride vehicle path 16. Other types of engagement between the ride vehicle 14 and the ride vehicle path 16 are also possible in accordance with the present disclosure. In some embodiments, the beam 34 may be coupled to the chassis 66 of the ride vehicle 14. The beam 34 may include an inner cavity 70 that may allow the beam 34 to pass over the motor 36. That is, the inner cavity 70 may receive the fin 64 of the motor 36. In some instances, an air gap 72 is created between the inner cavity 70 of the beam 34 and the motor 36. A magnetic force generated from an induced electrical current within the motor 36 (e.g., within or by the fin 64) may propel the ride vehicle 14 along the ride vehicle path 16. In some instances, the ride vehicle 14 may be accelerated, while in other instances the ride vehicle may be braked. To maintain the air gap 72 in certain embodiments, the absorbers 38 may be coupled to the motor 36 to absorb the downward movement (e.g., downward force) generated by the magnetic field and/or absorb the downward movement generated by contact between the beam 34 and/or the motor 36. In some instances, the beam 34 may include one or more guides 74 to direct the beam 34 along the ride vehicle path 16. The mounting plate 62 may be configured to engage with the absorbers 38 as the engagement (e.g., physical or magnetic engagement) between the beam 34 of the ride vehicle 14 and the motor 36 on the ride vehicle path 16 occur.

In some embodiments, the fin 64 corresponding to the motor 36 may include a chamfered edge 76 that, in certain operating conditions or ride cycles, contacts a front edge 78 of the beam 34. The chamfered edge 76 may be configured to force the fin 64 downwardly in response to said contact, against the force of the absorbers 38, which enable and dampen the movement of the motor 36 and corresponding fin 64. The contact between the fin 64 and the beam 34 does not cause undesirable interference. That is, the contact enables movement of the motor 36 including the fin 64 downwardly, such that wear, tear, fatigue, damage, or undesirable interference is avoided while still maintaining sufficient proximity between the motor 36 and the beam 34.

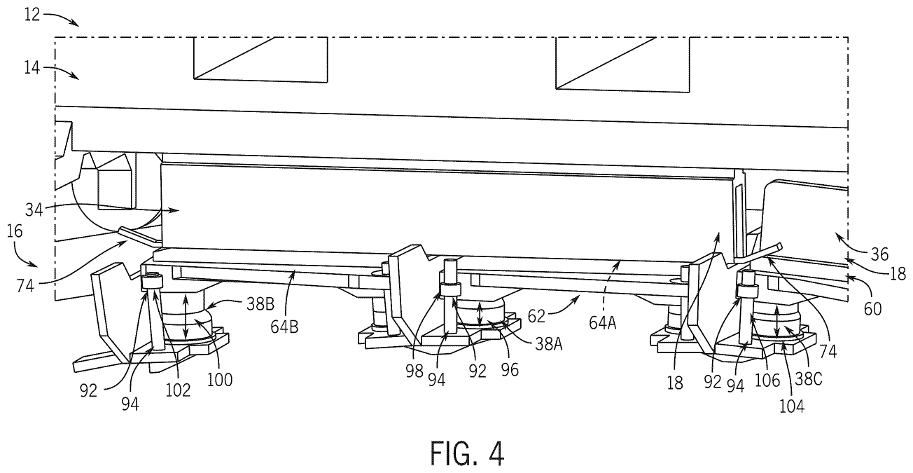

The above-described features of the propulsion assembly 18, along with additional features of the propulsion assembly 18, are illustrated in FIGS. 4-6. For example, FIG. 4 is a cross-sectional perspective view of an embodiment of the ride system 12 including the propulsion assembly 18. In the illustrated embodiment, the propulsion assembly 18 includes various features integrated with the ride vehicle path 16 (e.g., track) and/or the ride vehicle 14. An eye bolt 92 and a post 94 are integrated within the ride vehicle path 16 to allow the absorbers 38 to transfer force from the motor 36 as engagement between the motor 36 and the beam 34 occurs. The motor 36 may move vertically up or down with respect to a state (e.g., expanded, compressed) of the absorbers 38. The propulsion assembly 18 may include various absorbers 38. For example, the propulsion assembly 18 may include a first absorber 38A, a second absorber 38B, a third absorber 38C, and one or more additional absorbers.

For example, the first absorber 38A may be in a compressed state 96 when the beam 34 of the ride vehicle 14 is positioned over a first fin 64A hidden from view in the illustrated perspective as the first fin 64A is captured by the beam 34. The first absorber 38A may dampen engagement between the beam 34 and the motor 36 through compression of the first absorber 38A. Further, when the first absorber 38A is in the compressed state, the eye bolt 92 may change positions. That is, the eye bolt 92 may be positioned in a particular position 98 in relation to the post 94. Movement of the eye bolt 92 may allow the mounting plate 62 to move in conjunction with compression and/or extraction the first absorber 38A. The eye bolt 92 may be coupled to the post 94 to engage vertical movement of the mounting plate 62 in response to movement of the first absorber 38A. Further, the eye bolt 92 may prevent horizontal movement of the mounting plate 62. For example, in some embodiments, the second absorber 38B may be in an expanded state 100. The eye bolt 92 may be positioned at a top 102 of the associated post 94. As such, the mounting plate 62 may remain in an initial position as engagement of the beam 34 and a second fin 64B may not cause compression of the second absorber 38B. In some instances, the third absorber 38C may be in a relaxed state 104. The eye bolt 92 may be positioned at a relaxed position 106 of the associated post 94. It should be noted, that the absorbers 38 may be in various states of compression and/or expansion based on a degree of engagement of the beam 34 and the fin 64.

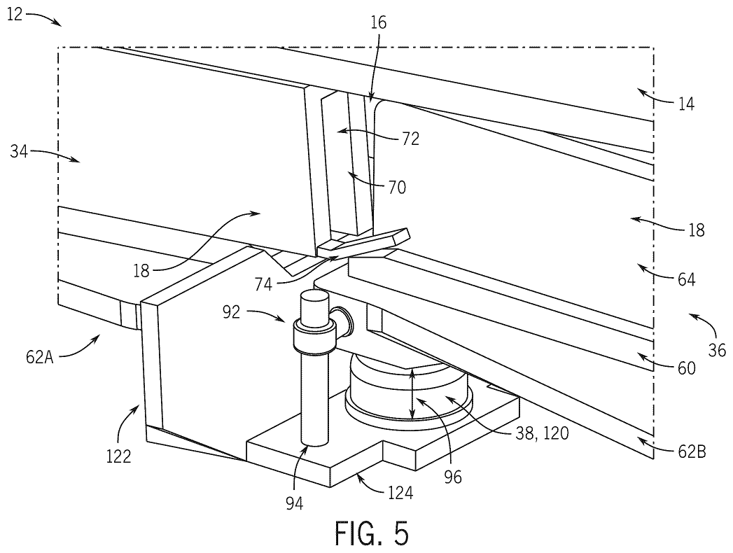

FIG. 5 is a schematic illustration of a portion of the ride system 12 of FIG. 1, including the propulsion assembly 18 and an absorber 38. In the illustrated embodiment, the absorber 38 is a bladder 120 (e.g., pneumatic bladder, air bladder) that may dampen the movement of the beam 34 coupled to the ride vehicle 14 as it passes over a motor 36. As described above, the fin 64 is coupled to a mounting block 60. In some embodiments, the mounting block 60 may be a part of the motor 36. The mounting block 60 may be further coupled to a mounting plate 62. The mounting block 60 may be mechanically and/or physically attached to the mounting plate 62. The ride vehicle path 16 may include a plurality of mounting plates 62 throughout portions of the ride vehicle path 16 in which the propulsion assembly 18 is positioned. A first mounting plate 62A may be positioned adjacent a second mounting plate 62B by way of a vertical plate 122. In some embodiments, the vertical plate 122 may be coupled to an absorber plate 124. The absorber plate 124 may support the absorber 38 (e.g., the bladder 120). Further, the absorber plate 124 may support the post 94. The post 94 may then be coupled to the eye bolt 92, which is coupled to the mounting plate 62. The ride vehicle path 16 may support various components (e.g., absorber, eye bolt, post, and the like) of the propulsion assembly 18.

In some embodiments, the inner cavity 70 of the beam 34 (e.g., magnetic beam) of the ride vehicle 14 may be directed by the guide 74 to pass over the fin 64. In some instances, a magnetic field is generated within the motor 36 to propel the ride vehicle 14 in response to the beam 34 entering the magnetic field. As the beam 34 moves through the magnetic field, the air gap 72 is formed to prevent contact between the beam 34 and the motor 36. In some instances, the guide 74 of the ride vehicle 14 may create a force on the mounting block 60 and/or the mounting plate 62 to engage the absorber 38, 120. The absorber 38 (e.g., air bladder 120) may move vertically to a state (e.g., compression state, expansion state) based on the force of the mounting block 60 and/or the mounting plate 62. As such, the air gap 72 may be maintained in certain embodiments to prevent contact between the beam 34 and the motor 36 while enabling propulsion of the ride vehicle 14 along the ride vehicle path 16. In some embodiments, some contact between the beam 34 and the motor 36 may be permitted without undesirable interference between them.

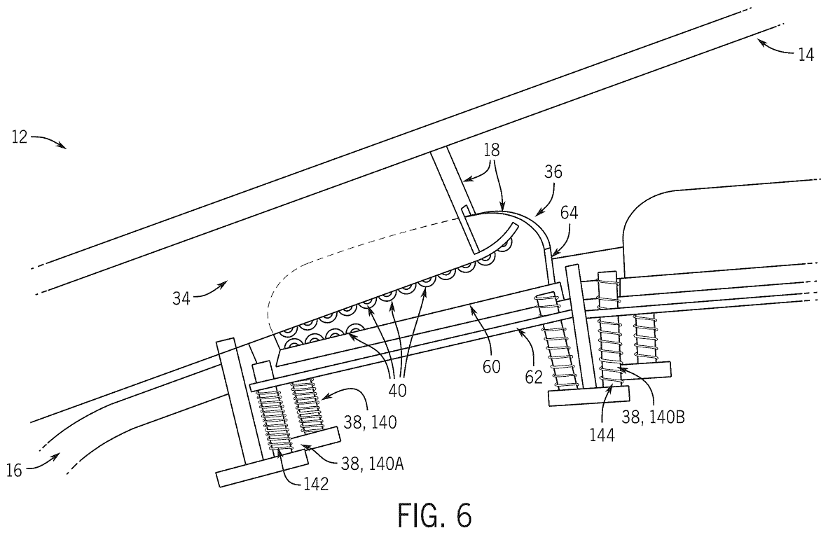

FIG. 6 is a schematic illustration of an embodiment of a portion of the ride system 12 that includes the propulsion assembly 18 having the one or more absorbers 38 and the one or more rollers 40. In the illustrated embodiment, the one or more absorbers 38 are springs 140. The springs 38, 140 are used to dampen the movement of the motor 36 as the fin 64 and the beam 34 engage with each other. In some embodiments, the springs 38, 140 may include compression springs, leaf springs, disk springs, and the like. For example, a first spring 38, 140A may be in a compressed state 142 as the ride vehicle 14 passes over motor 36 coupled to the mounting block 60 of the mounting plate 62. The compressed state of the first spring 38, 140A may allow a force from an engagement (e.g., contact, adjacency) of the beam 34 and the fin 64 to be reduced and/or negated. Further, in some instances, a second spring 38, 140B may be in an extended or relaxed state 144 (e.g., free length, body length) before and/or after the engagement between the beam 34 and the motor 36. The second spring 38, 140B may compress as the beam 34 of the ride vehicle 14 is propelled over the fin 64 in response to the beam 34 entering the magnetic field (e.g., generated by the motor 36).

In some embodiments, the rollers 40 of the propulsion assembly 18 may be positioned on the beam 34, the motor 36, or a combination thereof. The rollers 40 may include casters, roller bearings, nylon rollers, polyurethane rollers, rubber rollers, coated rollers, wheels, and the like. In the illustrated embodiment, the rollers 40 are disposed on the beam 34 and the motor 36. As the engagement between the beam 34 and the motor 36 occur the rollers 40 may reduce friction. As such, friction induced deceleration (e.g., slowing) due to contact between the beam 34 and the motor 36 may be reduced and/or negated. For example, as the beam 34 passes over the motor 36 and/or additional portions of the propulsion assembly 18 (such as the mounting block 60 and the mounting plate 62), sliding friction may occur due to the engagement if not for the rollers 40. The rollers 40 may convert sliding friction to rolling friction to reduce the force needed to move the ride vehicle 14 over a corresponding portion of the ride vehicle path 16. In some embodiments, the engagement between the beam 34 and the motor 36 may be reduced in instances in which the rollers 40 are used in combination with the absorbers 38. It should be noted, that while the illustrated embodiment demonstrates the use of springs 140 as the absorber 38 in combination with the rollers 40, other embodiments are envisioned in combination with the rollers 40. For example, presently disclosed embodiments may include bladders used in combination with the rollers 40.

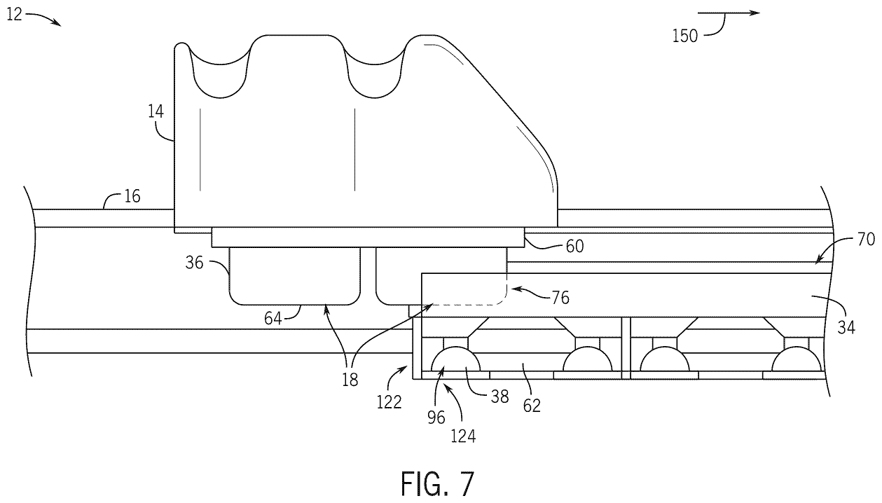

FIG. 7 is a schematic illustration of an embodiment of a portion of the ride system 12 that includes the propulsion assembly 18 having the beam 34 coupled to the ride vehicle path 16 instead of the ride vehicle 14, the motor 36 coupled to the ride vehicle 14 instead of the ride vehicle path 16, and the one or more absorbers 38. In the illustrated embodiment, the motor 36 is coupled to the ride vehicle 14 via the mounting block 60 (or otherwise forms a part of the mounting block 60). Further, the beam 34 is coupled to the mounting plate 62 disposed on the ride vehicle path 16. In some instances, the mounting plate 62 may be coupled to the vertical plate 122 and/or the absorber plate 124 of the ride vehicle path 16. The absorber plate 124 may support the absorbers 38. As the fin 64 of the ride vehicle 14 passes through the beam 34, the absorbers 38 may operate to enable and dampen an engagement between the motor 36 and the beam 34. The fin 64 may have a chamfered edge 76. The absorbers 38 may reduce a force due to the engagement and reduce wear, tear, and/or fatigue of one or more components of the propulsion assembly 18, while still promoting engagement between the motor 36 (e.g., the fin 64) and the beam 34. Further, in some instances, the beam 34 may be vertically displaced as the absorbers 38 dampen the engagement between the motor 36 and the beam 34.

In some embodiments, the controller as described in regards to FIG. 2 may control the motor 36 to generate a magnetic field. As the ride vehicle 14 passes over the beam 34 (e.g., magnetic beam) disposed on the ride vehicle path 16, the ride vehicle 14 may be propelled in response to interaction with the beam 34. That is, the magnetic field generated in the motor 36 coupled to the ride vehicle 14 may accelerate and/or decelerate based on interaction of the magnetic field and the beam 34. For example, in some instances, the beam 34 is a magnetic beam (e.g., permanent magnet, ferromagnetic material) and the motor 36 is an LSM. As such, as the LSM (e.g., electromagnet) approaches the magnetic beam the controller may selectively control a current directed through the LSM. The ride vehicle 14 may be configured to accelerate as it passes over the magnetic beam. For example, the LSM generates the magnetic field (e.g., traveling magnetic field) in a direction of travel 150 of the ride vehicle 14. In this manner, as the LIM interacts with the magnetic field, the ride vehicle 14 follows the magnetic field and induces linear motion in the direction of travel.

In some embodiments, the motor 36 is a LIM and the beam 34 is a non-ferrous material (e.g., aluminum, copper, and the like). The controller may generate a magnetic field in the LIM. As the LIM passes through the beam, eddy currents (e.g., according to Len's Law) may be induced. For example, the LIM may come into a sufficient proximity with the beam disposed on the ride vehicle path 16 to induce currents that cause a force (e.g., magnetic force) in a travel direction 150 of the ride vehicle 14. As such, the LIM engagement with the beam 34 may cause the ride vehicle 14 to accelerate (e.g., propel). Further, in some instances in which a proximity of the LIM and the beam 34 may lead to an engagement of the absorbers 38, the absorbers may dampen a force of the engagement by displacing the beam 34 from the ride vehicle path 16. The absorbers 38 may move to a compressed state 96 in response to engagement between the LIM and the beam.

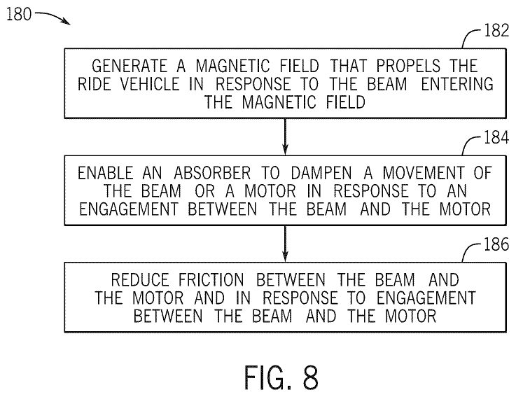

With the foregoing in mind, FIG. 8 is a flow chart of an embodiment of a method 180 for accelerating a ride vehicle via a propulsion assembly, such as the propulsion assembly 18 illustrated in FIGS. 1-7. In the illustrated embodiment, the method 180 includes generating (block 182) a magnetic field configured to propel a ride vehicle in response to a beam (e.g., magnetic beam, aluminum beam, and the like) entering the magnetic field. For example, a controller configured to control the propulsion assembly may direct a power source of a control system to generate the magnetic field via a motor of the propulsion assembly. The magnetic field may be generated by applying an alternating current to electromagnets within the motor to induce the magnetic field. The magnetic field establishes a force against the beam that accelerates (e.g., speeds up) the ride vehicle along a path of the ride vehicle. In some embodiments, the magnetic field may be generated in an opposite direction to brake (e.g., slow down) the ride vehicle as it passes over the propulsion assembly. Further, in some embodiments, as the beam passes over the motor, a force may be generated to propel the ride vehicle due to interaction of the beam and the magnetic field.

The method 180 also includes enabling (block 184) one or more absorbers to enable and dampen a movement of the beam or the motor in response to an engagement between the beam and the motor. As previously described, the beam may engage the motor and force the motor downwardly against a force exerted upwardly by the absorbers. In this way, sufficient proximity between the motor and the beam is enabled without undesirable interference between the motor and the beam. It should be noted that in some embodiments, a guide positioned on the beam may prevent direct engagement of the motor and the beam to prevent damage due to contact. With this in mind, the absorber may dampen movement of the beam and/or the motor.

In some embodiments, the method 180 includes reducing (block 186) friction between the beam and the motor in response to engagement between the beam and the motor. For example, friction may be reduced via one or more rollers positioned on the beam, the motor, or a combination thereof. The ride vehicle may pass over the propulsion assembly with minimal inhibition (e.g., deceleration) due to friction. Further, wear, tear, and/or fatigue on the beam and/or the motor is negated or reduced relative to traditional configurations while maintaining proximity between the beam and motor for propulsion of the ride vehicle.

While only certain features of the disclosed technology have been illustrated and described herein, many modifications and changes will occur to those skilled in the art. It is, therefore, to be understood that the appended claims are intended to cover all such modifications and changes as fall within the true spirit of the disclosure. Furthermore, although the steps of the disclosed flowchart/s are shown in a given order, in certain embodiments, the depicted steps may be reordered, altered, deleted, and/or occur simultaneously.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A propulsion assembly for a ride system, the propulsion assembly comprising:
a beam;
a motor configured to generate a magnetic field that propels a ride vehicle of the ride system in response to the beam entering the magnetic field; and
an absorber configured to enable and dampen a movement of the beam or the motor in response to an engagement between the beam and the motor.

2. The propulsion assembly of claim 1, wherein the motor comprises a linear synchronous motor (LSM) or a linear induction motor (LIM).

3. The propulsion assembly of claim 1, wherein the beam is disposed on the ride vehicle.

4. The propulsion assembly of claim 1, wherein the beam is disposed on a track of the ride system.

5. The propulsion assembly of claim 1, wherein the absorber comprises a bladder or a spring.

6. The propulsion assembly of claim 1, comprising a roller configured to reduce friction between the beam and the motor and in response to the engagement between the beam and the motor, wherein the roller is disposed on the beam or the motor.

7. The propulsion assembly of claim 1, wherein the motor comprises a fin and the absorber is configured to enable and dampen the movement of the beam or the fin in response to the engagement between the beam and the fin.

8. The propulsion assembly of claim 1, comprising a controller configured to selectively control a current directed through the motor.

9. The propulsion assembly of claim 8, wherein the controller is configured to selectively control the current directed through the motor based on sensor feedback indicative of a characteristic of the ride system.

10. The propulsion assembly of claim 8, comprising an actuator, wherein the controller is configured to selectively control the actuator to change a relative positioning between the beam and the motor.

11. A ride system, comprising:
a ride vehicle path;
a ride vehicle;
a beam integrated with one of the ride vehicle path or the ride vehicle;
a motor integrated with the other of the ride vehicle path or the ride vehicle;
a controller configured to selectively control a current directed to the motor to generate a magnetic field that propels the ride vehicle in response to the beam entering the magnetic field; and
an absorber configured to enable and dampen a movement of the beam or the motor in response to an engagement between the beam and the motor.

12. The ride system of claim 11, wherein the motor is coupled to the ride vehicle path.

13. The ride system of claim 11, wherein the absorber comprises a spring or a bladder.

14. The ride system of claim 11, wherein the motor comprises a fin configured to establish a position of the magnetic field.

15. The ride system of claim 11, wherein the beam is a magnetic beam.

16. The ride system of claim 11, wherein the beam is disposed on a chassis of the ride vehicle.

17. A method of propelling a ride vehicle of a ride system, the method comprising:
generating, via a motor, a magnetic field that propels a ride vehicle in response to a beam entering the magnetic field; and
dampening a movement of the beam or the motor via an absorber and in response to an engagement between the beam and the motor.

18. The method of claim 17, comprising selectively controlling a current directed to the motor via a controller.

19. The method of claim 17, comprising dampening the movement by compressing the absorber in response to the engagement.

20. The method of claim 17, comprising a roller configured to reduce friction between the beam and the motor and in response to the engagement between the beam and the motor.
